(19) United States
(12) Patent Application Publication
(10) Pub. No.: US 2025/0390938 A1
(43) Pub. Date: Dec. 25, 2025

(54) AI SYSTEM FOR PERSONALIZED VACATION RENTAL PROPERTY MANAGEMENT

(71) Applicant: CELLIGENCE INTERNATIONAL LLC, Guaynabo, PR (US)

(72) Inventors: Pavan AGARWAL, DORADO, PR (US); Gabriel Albors SANCHEZ, SAN JUAN, PR (US); Jonathan Ortiz RIVERA, SAN JUAN, PR (US)

(73) Assignee: CELLIGENCE INTERNATIONAL LLC, Guaynabo, PR (US)

(21) Appl. No.: 19/302,992

(22) Filed: Aug. 18, 2025

Related U.S. Application Data
(63) Continuation-in-part of application No. 18/135,703, filed on Apr. 17, 2023, now Pat. No. 12,393,433.
(60) Provisional application No. 63/332,205, filed on Apr. 18, 2022.

(51) Int. Cl. G06Q 30/0645; G06Q 10/02; G06Q 30/0282; G06Q 50/163; H04L 67/12

(52) U.S. Cl. CPC G06Q 30/0645; G06Q 10/02; G06Q 30/0282; G06Q 50/163; H04L 67/12

(57) ABSTRACT

A system and method for managing guest interactions in vacation rental properties using an AI-driven conversational interface. Each property is associated with a customized account storing owner-defined rules, preferences, and media. Guests interact with the system through a chat interface to receive personalized responses generated based on emotional tone, contextual intent, and historical data. A guest interaction engine processes input and routes queries through a property rules processor, knowledge base, and response generation module. A personalization profile manager adapts future interactions based on guest behavior and sentiment. An owner console enables hosts to configure welcome messages, select AI voice characteristics, manage property photos, and monitor current guests. The system supports multi-property accounts, escalation pathways, and integration with external services for real-time updates, navigation, and verification. The disclosed technology improves operational efficiency for hosts and enhances the guest experience through intelligent automation, tone-adaptive responses, and property-specific customization.

### RELATED APPLICATIONS

This application a continuation-in-part of U.S. patent application Ser. No. 18/135,703, filed on Apr. 17, 2023, which claims the benefit of U.S. Provisional Application No. 63/332,205 filed on Apr. 18, 2022, the contents of which are incorporated herein by reference in its entirety.

### BACKGROUND

Vacation rental properties, including short-term rentals offered through platforms such as Airbnb®, Vrbo®, and similar marketplaces, have become an increasingly popular lodging option for travelers seeking unique accommodations. However, property owners and managers often face challenges in maintaining high-quality guest experiences while efficiently managing operational responsibilities across multiple properties.

Traditional property management systems may include manual onboarding procedures, generic communication templates, or rigid automation rules that fail to adapt to specific guest needs or contextual nuances. These approaches often require frequent manual intervention from the property owner or staff, particularly when addressing common guest inquiries (e.g., check-in instructions, Wi-Fi access, nearby attractions), managing maintenance alerts, or updating local recommendations. Such inefficiencies can degrade guest satisfaction and increase operational burdens.

While some digital assistants and messaging bots exist, they are typically not customized to the nuances of each property or to the preferences of the individual host. Furthermore, these conventional systems lack the ability to dynamically learn from prior interactions, personalize recommendations based on guest profiles, or adapt communication tone based on sentiment cues.

Moreover, existing solutions often treat each guest interaction as a one-off engagement, without persistent memory or cross-property optimization. In environments where property owners manage multiple listings, current systems provide little support for unified management, AI-based personalization, or escalation pathways across different properties.

There is, therefore, a need for an intelligent, modular system capable of managing guest interactions and property operations in a personalized and scalable manner. Such a system should allow property owners to configure AI-driven assistants that are tailored to individual rentals, support personalized communication, and automate repetitive tasks while preserving the owner's distinctive voice and brand. The disclosed system addresses these and other shortcomings in conventional vacation rental management technology.

### SUMMARY

Systems and methods are disclosed for managing guest interactions and automating operational tasks in vacation rental properties using an AI-powered conversational interface. The system enables each vacation rental property to be associated with a dedicated account containing owner-defined preferences, property rules, multimedia assets, and configuration data.

In some embodiments, a guest accesses a chat interface on a client device to communicate with a virtual assistant. The guest's input is processed by a guest interaction engine that detects emotional tone and conversational intent. A property rules processor classifies the request in view of the owner's configurations and, where applicable, retrieves relevant content from a knowledge base module. A response generation module creates a personalized reply adapted to the guest's tone, profile, and contextual data. The response is then transmitted to the guest and logged for future personalization.

A personalization profile manager continuously refines guest interaction patterns based on feedback signals such as prompt selections, response engagement, and emotional cues. If certain escalation criteria are met, the system may activate a maintenance and alert module to notify the property owner or support staff.

The system further includes an owner console interface that allows hosts to configure welcome messages, select or upload sample property photos, define descriptive tags or features, and customize the AI assistant's voice persona. In multi-property implementations, the owner console also supports switching between listings, monitoring current guests, and initiating direct or escalated communication when needed.

External data sources such as reservation APIs, navigation services, and content verification platforms may be integrated to provide dynamic updates and enrich both guest and host interactions.

By combining tone-aware natural language processing, contextual automation, and owner-facing customization tools, the disclosed system enhances the vacation rental experience for both guests and property managers while reducing manual effort and maintaining brand consistency.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a block diagram illustrating an exemplary system architecture for a vacation rental AI management system AI voice call initiation, according to an implementation of the disclosure.

FIG. 2 is a flowchart illustrating a guest interaction workflow driven by AI modules, according to an implementation of the disclosure.

FIG. 3 is a graphical user interface (GUI) illustrating a guest-facing chat interface presented via a mobile, according to an implementation of the disclosure.

FIG. 4A-4C illustrate owner console GUI views, according to an implementation of the disclosure.

FIG. 5 illustrates an example computing system that may be used in implementing various features of embodiments of the disclosed technology.

Described herein are systems and methods for AI-driven guest interaction and vacation rental property management that combine personalized response generation, emotional tone adaptation, and property-specific customization to deliver context-aware, efficient, and engaging guest experiences. The system enables dynamic communication between guests and a virtual assistant configured for each property, while also providing owners with a control interface to manage AI voice settings, media, and rules. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

The disclosed system provides a novel AI-driven property management architecture that enhances guest experiences in vacation rental environments through real-time conversational interaction, dynamic personalization, and intelligent automation of owner-defined preferences and rules. By integrating contextual recommendation engines, adaptive guest profiling, and structured feedback loops, the system transforms static property listings into responsive, intelligent concierge experiences. The architecture also reduces operational burdens for property owners by automating routine inquiries, enforcing house policies through AI-generated responses, and escalating maintenance issues when needed—all while maintaining high levels of guest satisfaction and trust through transparent, human-like interactions.

In some embodiments, the system described herein may incorporate architecture, data pipelines, and functional models disclosed in U.S. Provisional Application No. 63/709,349, filed Oct. 18, 2024, titled “System for Generating a Knowledge Base from Group Chat Data by Leveraging AI Models.” This may include, but is not limited to, classification models for intent detection, entity extraction models, and procedural function engines for dynamic response generation. These components may be used to support intelligent guest interactions, contextual understanding, and automated handling of vacation rental inquiries based on structured and unstructured data inputs.

Conventional property management systems and digital vacation rental platforms are largely static, offering limited or no real-time interaction between guests and property owners. Guests typically rely on PDF manuals, pre-written FAQs, or delayed messaging threads to find answers to property-related questions. These systems do not adapt to individual guest preferences, cannot synthesize recommendations from context (e.g., location, time of day, or travel history), and often fail to enforce owner-defined rules dynamically. Moreover, traditional platforms place the burden of guest communication, issue resolution, and content updates squarely on the property owner, resulting in increased operational overhead. Because these systems lack conversational AI interfaces, they are unable to deliver proactive suggestions, refine their responses through user interaction, or route maintenance requests in a structured, automated fashion. As a result, guest experiences remain impersonal and fragmented, and property owners must continually intervene to manage stay-related logistics, answer redundant questions, or manually relay information that could otherwise be learned and delivered intelligently.

The disclosed system introduces several technical improvements over conventional static rental platforms and FAQ-based solutions. By leveraging an integrated architecture that includes a property-specific knowledge base, real-time conversational interface, and AI-driven procedural response generation, the system enables dynamic adaptation to individual guest contexts and preferences. Unlike keyword-based systems, the response generation module employs classification, entity extraction, and procedural function orchestration to construct contextually accurate and personalized replies. The integration of a property rules processor ensures automated enforcement of owner-specified constraints at runtime, without requiring owner intervention. Furthermore, guest interactions are continuously analyzed by a personalization profile manager and feedback analysis engine, enabling the system to refine its recommendations, detect recurring issues, and update AI behavior based on satisfaction trends. These improvements are rooted in a technical framework that enables modular scaling across properties, asynchronous issue routing, and intelligent dialog flows—features that materially enhance the utility and responsiveness of digital property management while minimizing manual oversight.

Collectively, these technical improvements deliver a dual benefit: guests receive a seamless, intelligent, and highly personalized stay experience, while property owners gain operational efficiency through automation, reduced communication overhead, and timely escalation of actionable issues. The system's modular architecture allows it to scale across multiple properties with individualized configurations, ensuring that each property's character, rules, and local context are preserved within the AI-driven interface. As described in further detail below with reference to the accompanying figures, the disclosed system provides a robust framework for modernizing short-term rental management using applied AI technologies and dynamic conversational logic.

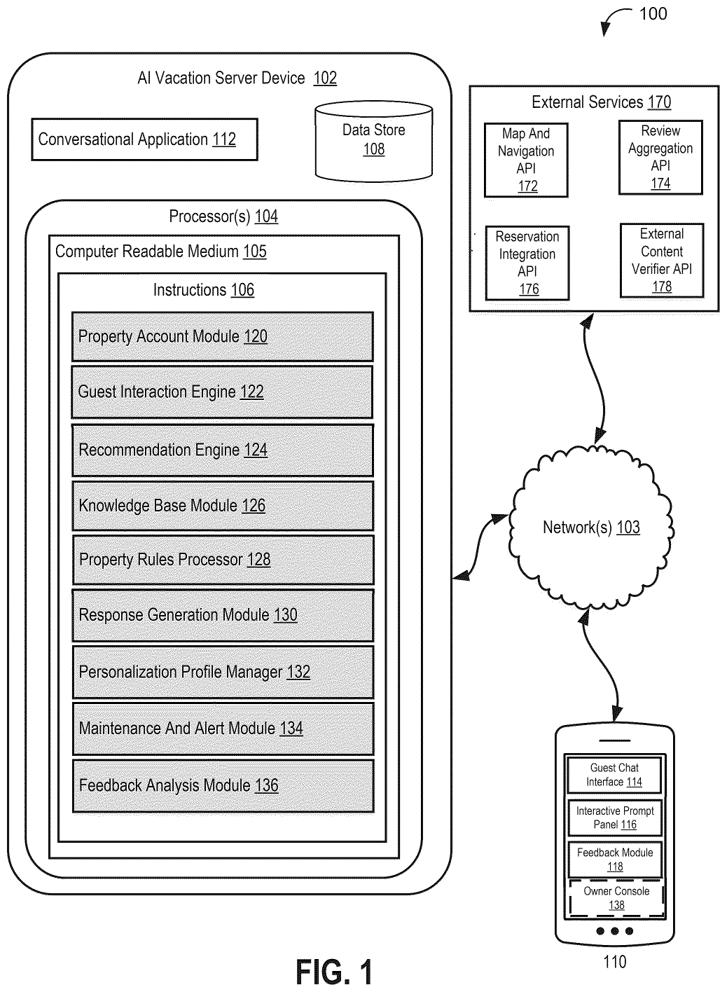

The disclosed system operates within a modular, service-oriented architecture designed to support scalable, personalized guest interactions and automated property management workflows. FIG. 1 provides a high-level system overview, illustrating key functional modules and data flows between component.

At a high level, the system includes: (i) a property account module (120); (ii) a guest interaction engine (122); (iii) a guest chat interface (124); (iv) a knowledge base module (126); (v) a personalization profile manager (128); (vi) a rules and escalation engine (130); (vii) an AI voice configuration manager (132); (viii) an owner console interface (134); (ix) a maintenance and alert module (136); and (x) a training and adaptation engine (138).

These components may be deployed in a cloud-hosted environment and communicate over secured APIs and message protocols. The architecture supports multi-property accounts, dynamic tone and content generation, and integration with external services such as reservation platforms and mapping providers.

FIG. 1 illustrates an example system architecture 100 for an AI-powered Vacation Rental Property Management System, including an AI Vacation Server Device 102, a guest device 110, external APIs and databases 170, and a network 103 configured to facilitate real-time interaction, recommendation delivery, and automated property oversight.

The AI Vacation Server Device 102 includes one or more processors 104 and a computer-readable medium 105 that stores executable instructions 106 comprising a set of functional modules that collectively power the personalized guest experience and automated property management functionality. These modules include: a Property Account Module 120 configured to store property-specific configurations, including check-in instructions, amenities, owner rules, and preferred voice or branding styles; a Guest Interaction Engine 122 for managing real-time conversational input via text or voice; a Recommendation Engine 124 that synthesizes contextual suggestions for dining, attractions, and activities; a Knowledge Base Module 126 for persisting owner-uploaded FAQs and past guest interactions; a Property Rules Processor 128 that applies constraints or behavioral rules during real-time dialogue generation; a Response Generation Module 130 that utilizes classification, entity extraction, and procedural logic to formulate natural language responses; a Personalization Profile Manager 132 that adapts guest interaction style based on historical usage or detected preferences; a Maintenance and Alert Module 134 for routing guest-reported issues to owners or vendors; and a Feedback Analysis Engine 136 that ingests structured and unstructured guest reviews for post-stay analytics and retraining purposes.

The system also includes a Conversational Application 112 that serves as the API layer and orchestration point between guest-facing interfaces and backend logic, and a Data Store 108 that maintains structured records for property configurations, guest profiles, chat transcripts, rule sets, and recommendations.

The guest device 110 may include a mobile phone, tablet, or wearable device, and presents three modular UI components: a Guest Chat Interface 114 for real-time messaging with the AI assistant; an Interactive Prompt Panel 116 configured to surface context-sensitive questions and short action prompts (e.g., “Check-out instructions,” “Book dinner nearby”); and a Feedback Module 118 for guests to submit ratings, flag issues, or leave free-form comments. Each of these UI components may be rendered separately or integrated into a single conversational view, and may be selectively shown or hidden based on system state or user preference.

The AI vacation system can also access external APIs and data sources 170 through network 103. These external systems may include a Map and Navigation API 172 for providing geolocation-based check-in support or directions to local landmarks; a Review Aggregator API 174 for sourcing quality metrics on restaurants, venues, and service providers; a Reservation Integration API 176 to support in-app bookings; and an External Content Verifier API 178 to confirm the accuracy of time-sensitive information such as event schedules, business hours, or safety alerts.

Hardware processor 104 may include one or more central processing units (CPUs), graphics processing units (GPUs), semiconductor-based microprocessors, or specialized accelerators (such as FPGAs or ASICs) configured to retrieve and execute instructions stored in computer-readable medium 105. The processor executes operations for generating dynamic guest responses, enforcing property rules, analyzing guest feedback, and orchestrating personalized content delivery. In some embodiments, processor 104 includes circuitry for handling real-time interaction flows while maintaining low-latency communication with the guest device 110.

A computer-readable medium 105 may be implemented using any suitable storage technology including RAM, non-volatile RAM (NVRAM), solid-state drives, or cloud-hosted object storage systems. In some embodiments, medium 105 is a non-transitory storage medium encoded with executable instructions 106 that correspond to modules 120 through 136 described herein. The storage medium may further persist historical chat transcripts, structured guest feedback, and owner rule profiles for long-term personalization and analytics.

The disclosed system operates within a modular AI architecture designed to deliver responsive, context-aware guest experiences while automating key operational functions on behalf of the property owner. FIG. 1 depicts the key server-side, client-side, and third-party integrations that support this objective.

At a high level, the system includes (i) a property-specific configuration and rule-processing layer, (ii) a real-time AI assistant for handling guest conversations, (iii) recommendation and personalization subsystems for tailoring suggestions, (iv) a feedback capture and analysis pipeline, and (v) external data integrations for mapping, review enrichment, and booking fulfillment.

These components may be deployed in a cloud-hosted or hybrid edge-cloud architecture and may communicate via secured HTTPS, WebSocket, or message-queue protocols. The architecture is designed for scalable deployment across multiple rental properties, with the ability to create and manage per-property Angel AI instances with distinct behavior and voice. In the following sections, each module is described in further detail with reference to specific functions, interactions, and user interface elements.

The Property Account Module 120 is configured to store and manage configuration data unique to each vacation rental property. This includes, but is not limited to, the property name, physical address, check-in and check-out instructions, Wi-Fi credentials, amenity listings, emergency contact details, and branding preferences. In some embodiments, the module also stores a host profile image and welcome message text that are rendered upon guest arrival via the guest device 110.

The module enables property owners to define structured rules and behavioral policies for the AI assistant, including quiet hours, smoking restrictions, pet permissions, visitor limitations, appliance usage guidelines, and any other customized house rules. These rules are tagged with metadata (e.g., rule type, severity, enforcement scope) and stored in association with a specific property identifier.

In multi-property scenarios, Property Account Module 120 may support hierarchical or multi-tenant configurations, allowing property managers to configure a portfolio of properties, each with individualized AI behavior and branding. The module supports version control, allowing owners to update policies or content without affecting in-flight guest interactions. Historical versions of property rules and content may be retained for auditing or troubleshooting purposes.

In some embodiments, the Property Account Module 120 may expose an owner-facing configuration interface (via the Owner Console Module 106) through which the owner may upload rule templates, images, localized content, and prewritten FAQ entries. The configuration interface may include access control logic such that property owners, management companies, and delegated staff have tiered permissions.

The structured data stored in Property Account Module 120 is consumed by downstream modules including the Guest Interaction Engine 122, Property Rules Processor 128, and Response Generation Module 130. This allows the AI assistant to tailor its responses and behavioral logic according to the specific characteristics and requirements of the rental property in which the guest is staying. In this way, the Property Account Module 120 serves as the foundational context for personalized guest interaction and rule enforcement across the platform.

The Guest Interaction Engine 122 is configured to manage real-time conversational exchanges between the guest and the AI assistant during the course of a rental stay. It supports both text-based and, in some embodiments, voice-based input, and is responsible for processing natural language queries, initiating appropriate system workflows, and delivering context-aware responses via the Guest Chat Interface 114.

The engine operates as the first point of contact for guest input and includes an embedded intent classifier and entity extractor. These subcomponents analyze incoming queries to determine guest intent (e.g., request for check-out time, Wi-Fi password, restaurant recommendation, etc.) and extract relevant entities such as place names, dates, or appliance references. In some embodiments, the engine leverages machine learning models trained on historical guest interactions and domain-specific datasets to improve accuracy.

The Guest Interaction Engine 122 maintains conversational context over the course of a session and can track follow-up queries, clarifications, or corrections. For example, if a guest asks, “Where should we go for dinner?” and then follows up with, “Something casual nearby,” the engine uses the prior exchange to disambiguate the request and refine the recommendation. Context persistence is maintained in memory and may be cleared, updated, or archived depending on session boundaries or guest preferences.

In some embodiments, the engine is also capable of detecting emotional tone or urgency in guest messages. For instance, if a guest writes “The heat isn't working and it's freezing,” the engine may tag the query as urgent and automatically route it to the Maintenance and Alert Module 134 for escalation. This prioritization may be accompanied by a real-time response confirming receipt and providing expected response time.

The Guest Interaction Engine 122 interfaces directly with the Property Account Module 120 to ensure that property-specific rules and owner preferences are respected. For example, if a guest asks, “Can we invite friends over tonight?” the engine checks the property's visitor policy and generates a compliant response accordingly. Similarly, the engine may consult the Knowledge Base 126 to retrieve property-specific FAQs or past interactions relevant to the guest's request.

In some embodiments, the engine may log anonymized interaction patterns for analysis by the Feedback Analysis Engine 136 or for training future versions of the intent and entity models. These logs may include timestamps, extracted parameters, resolved intents, and conversational outcomes (e.g., issue resolved, owner escalation triggered, guest satisfaction confirmed).

The Recommendation Engine 124 is configured to generate personalized suggestions for dining, entertainment, local attractions, and activities based on a combination of guest preferences, real-time context, and property location. This module plays a central role in enriching the guest's travel experience and transforming static rental stays into dynamic, curated journeys.

The engine synthesizes multiple input signals to formulate relevant recommendations. These inputs may include the guest's current geolocation (as reported by guest device 110), the time of day and day of the week, historical preferences derived from Personalization Profile Manager 132, prior guest interactions stored in Knowledge Base 126, and parameters specified in the Property Account Module 120 (e.g., proximity to walkable areas, quiet zones, or family-friendly venues).

Recommendations may be generated proactively—for example, shortly after check-in, the guest may receive a welcome message that includes a curated list of local restaurants or scenic walks—or reactively in response to explicit guest requests such as, “What should we do tonight?” or “Where can we get breakfast nearby?” The module may interface with external services 170, including Review Aggregator API 174 and Reservation Integration API 176, to verify opening hours, quality ratings, and availability.

The engine supports filtering and ranking logic that adapts recommendations according to contextual constraints. For instance, if a guest asks for “something casual nearby,” the engine may use natural language modifiers (“casual,” “nearby”) to adjust its filtering logic. Similarly, if the Property Rules Processor 128 specifies noise restrictions or curfews, the engine may avoid suggesting loud or late-night venues.

In some embodiments, Recommendation Engine 124 may use collaborative filtering or pattern matching across similar guest profiles to suggest experiences that have historically been well-received by users with analogous preferences or demographics. The engine may also adjust rankings over time based on feedback collected through Feedback Module 118 (e.g., “Was this place helpful?”).

The recommendations generated by the engine are formatted as natural language responses and transmitted via the Guest Chat Interface 114. In some cases, these may be accompanied by embedded links, interactive buttons (e.g., “Book now”), map previews, or rich media. The results may also populate the Interactive Prompt Panel 116, enabling guests to discover options without needing to phrase specific queries.

The Recommendation Engine 124 is tightly integrated with the rest of the AI system and serves as one of the primary value drivers of the guest experience layer. It reduces decision fatigue, enhances local exploration, and reflects the owner's hospitality preferences through contextualized, intelligent content delivery.

The Knowledge Base Module 126 is configured to maintain a structured, property-specific repository of data that supports intelligent, context-aware responses by the AI assistant. Unlike static documents or hard-coded FAQ lists, this module dynamically aggregates and organizes historical guest interactions, owner-provided content, and verified facts into a machine-readable format that can be queried in real time by other system modules.

The module ingests data from multiple sources, including: (i) rule and preference data from Property Account Module 120; (ii) resolved queries and conversation transcripts from Guest Interaction Engine 122; (iii) crowd-sourced recommendations and third-party content retrieved via external services 170; and (iv) feedback entries submitted through Feedback Module 118. In some embodiments, the Knowledge Base 126 also includes curated answers to frequently asked questions (e.g., “Where is the thermostat?”), annotated with relevance scores and temporal metadata.

The stored content is indexed by property identifier, topic, intent type, and confidence level, allowing for rapid retrieval during ongoing guest interactions. When a guest poses a question, the system first checks the Knowledge Base 126 for a previously answered or system-validated response before engaging procedural logic or external data sources. This reduces response time and increases consistency across stays.

The Knowledge Base may be periodically updated through automated content enrichment processes. For example, when multiple guests ask variations of the same question and receive similar responses, the system may automatically promote the answer into the knowledge base for future reuse. Similarly, when owners update property rules, appliance instructions, or local suggestions through the Owner Console (described with module 106), those updates are immediately reflected in the knowledge base for that property.

In some embodiments, Knowledge Base Module 126 may include logic for confidence scoring and response prioritization. When multiple candidate answers exist (e.g., from prior conversations or owner-uploaded FAQs), the module selects the most contextually appropriate one based on factors such as recency, user profile similarity, query wording, or emotional tone.

The Knowledge Base may also store and surface structured metadata, such as location tags, appliance serial numbers, local safety contact details, or timezone-adjusted check-out times. This structured content can be used not only for generating replies, but also for validating requests, detecting anomalies, or offering personalized upsells.

By serving as a centralized memory layer for each property's Angel AI instance, the Knowledge Base Module 126 enables the system to deliver consistent, scalable, and human-like service without requiring the property owner to manually respond to repetitive inquiries.

The Property Rules Processor 128 is configured to interpret and enforce owner-defined rules and behavioral constraints in real time during guest interactions. These rules may include quiet hours, pet restrictions, smoking prohibitions, guest limits, amenity usage policies, and other property-specific conditions that affect how the Angel AI assistant responds to guest requests.

At runtime, when a guest submits a query—such as “Can I invite friends over tonight?” or “Is it okay to use the hot tub after midnight?”—the Property Rules Processor 128 cross-references the query with structured rule data stored in the Property Account Module 120. If the requested action violates a defined rule, the processor dynamically modifies or filters the AI-generated response to comply with the owner's policies. For example, the system might respond, “The property's quiet hours begin at 10:00 PM, so the hot tub is unavailable after that time.”

Rules may be defined using structured templates, uploaded documents, or owner-provided text, which are parsed and normalized into a machine-readable format. The Property Rules Processor 128 tags each rule with metadata such as severity level, enforcement method (hard block, soft warning, informational), and applicability scope (e.g., time-based, guest-type specific, conditional). These tags are used by other modules—such as Response Generation Module 130 and Recommendation Engine 124—to tailor their behavior accordingly.

In some embodiments, the processor includes logic for conditional rule interpretation. For example, a rule stating “No parties unless pre-approved” may trigger a disambiguation prompt or escalation to the owner if the guest's request falls into a gray area. The system can also detect cumulative rule violations across interactions and raise alerts if a guest repeatedly attempts to bypass constraints.

The Property Rules Processor 128 can operate both proactively and reactively. Proactively, it may annotate suggested activities or recommendations to reflect policy restrictions (e.g., suppressing loud venues during quiet hours). Reactively, it ensures that answers to direct questions never contradict the owner's predefined rules, regardless of guest phrasing or intent detection ambiguity.

In some embodiments, rule enforcement outcomes—such as denied requests, modified responses, or triggered alerts—are logged to the Data Store 108 and may be reviewed by property owners through the Owner Console. This provides transparency and accountability, and helps owners refine their policy settings over time.

By integrating seamlessly with upstream interaction and downstream response generation workflows, the Property Rules Processor 128 ensures that each Angel AI instance not only provides helpful guidance to guests, but also does so within the boundaries of the specific property's house rules and expectations—without requiring constant owner oversight.

The Response Generation Module 130 is responsible for composing natural language replies to guest queries, drawing on intent classification, entity extraction, and procedural logic to ensure that responses are contextually accurate, compliant with property rules, and aligned with the guest's preferences and location. This module serves as the core synthesis engine that transforms structured data, real-time context, and rule constraints into fluid, conversational output.

When the Guest Interaction Engine 122 receives a guest inquiry, it forwards the classified intent and extracted entities to the Response Generation Module 130. The module then consults relevant data sources—including the Knowledge Base 126, Property Account Module 120, and any active recommendations or feedback signals—to determine the appropriate response template or procedural action. The module may select from a library of predefined response frames, dynamically populated with content based on the query parameters.

In one embodiment, the module leverages a procedural function framework (e.g., as described in application 57BL-386839) to orchestrate task-specific operations based on detected intent. For example, if the guest asks, “Can I check out late?” the module may trigger a procedural function that (i) checks the current check-out time from the Property Account Module 120, (ii) verifies against any late check-out permissions or rules via Property Rules Processor 128, and (iii) composes a response that reflects current policy and availability.

The module may also retrieve prior responses to similar questions from the Knowledge Base 126, adjusting them based on the current guest's profile, local time, or recent interactions. In some embodiments, the Response Generation Module 130 can combine content from multiple sources, such as blending a location-specific restaurant recommendation with a reminder about the property's curfew policy.

The final response is composed as structured conversational text and returned to the guest device 110 via the Guest Chat Interface 114. In some cases, the response may include embedded metadata such as urgency level, associated prompts for Interactive Prompt Panel 116, or feedback capture hooks for module 118. Rich responses may also include hyperlinks, reservation buttons, map previews, or personalization tags (e.g., addressing the guest by name).

In some embodiments, the module includes fallback handling logic. If confidence in the proposed response falls below a threshold—or if multiple conflicting data sources are detected—the module may either request clarification from the guest or escalate to the property owner (e.g., via the Owner Console). The module may also generate a placeholder response while verification is pending (e.g., “Let me check that for you—please hold one moment”).

All generated responses are logged along with their input parameters and resolution outcomes in the Data Store 108 for auditability, training, and feedback analysis. Over time, these logs are analyzed by the Feedback Analysis Engine 136 to improve response quality, identify system gaps, and retrain components of the conversational pipeline.

Through this architecture, the Response Generation Module 130 enables the Angel AI system to deliver fast, natural, and property-specific replies to guest inquiries, minimizing owner intervention while maintaining a high standard of hospitality and compliance.

The Personalization Profile Manager 132 is configured to construct and refine individualized guest profiles based on real-time interactions, historical behavior, expressed preferences, and inferred attributes. This module enables the Angel AI system to tailor its communication style, content prioritization, and recommendations to the unique needs and expectations of each guest, even within the same rental property.

Upon the start of a guest session (e.g., upon check-in or first interaction), the system may initialize a new profile or retrieve a returning guest's historical profile, if available and authorized. The profile may include demographic markers (e.g., language preference, traveling with family), interaction tone (e.g., casual vs. formal), prior feedback sentiment, preferred types of activities (e.g., outdoor, nightlife, dining), and behavioral patterns (e.g., frequent use of prompt suggestions vs. free-text queries).

The module continuously updates the guest profile during the stay. For example, if the guest frequently clicks on restaurant recommendations with vegetarian labels, or responds positively to earlier suggestions involving art museums, the system may weight future recommendations accordingly. These signals may be collected from the Guest Interaction Engine 122, the Feedback Module 118, and interaction metadata captured in the Guest Chat Interface 114.

The Personalization Profile Manager 132 also governs how information is presented to the guest. For instance, if the profile suggests the guest prefers concise replies, the Response Generation Module 130 may deliver shorter, bullet-style responses. If a guest has shown interest in live music venues and the day is Friday evening, the Recommendation Engine 124 may proactively surface music-related events via the Interactive Prompt Panel 116.

In some embodiments, the module includes logic for segmenting or clustering guest types. For example, first-time international travelers, families with young children, or digital nomads may be identified based on their interactions and grouped into behavioral archetypes. These archetypes may be used to initialize recommendation heuristics and tone settings before sufficient per-user data is available.

Profiles are scoped at the individual level, but may also incorporate session context or device type. For example, the AI may respond more concisely on mobile than on tablet, or defer complex content when the guest is detected to be in transit. If multiple guests are associated with the same booking, the system may distinguish interactions by user ID or device.

Guest profiles are stored securely within the system and may include retention rules or anonymization protocols to comply with privacy regulations and property management platform policies. Guests may opt to clear or persist their preferences across stays if supported by the broader platform.

The Personalization Profile Manager 132 acts as a dynamic context memory that enables the Angel AI system to move beyond one-size-fits-all interactions, offering instead a hospitality layer that adapts not only to the property but to each guest's individual preferences, behaviors, and communication style.

The Maintenance and Alert Module 134 is configured to detect, route, and escalate guest-reported issues or system-detected anomalies related to the condition, operation, or safety of the vacation rental property. This module enables proactive and structured issue resolution without requiring the guest to manually contact the property owner or navigate third-party platforms.

When a guest reports a problem through the Guest Chat Interface 114 or the Feedback Module 118—such as “the heater isn't working” or “there's a leak under the sink”—the system recognizes the intent as a maintenance-related issue. The Guest Interaction Engine 122 passes the query to the Maintenance and Alert Module 134, which categorizes the issue and determines the appropriate routing path based on severity, time of day, and property configuration.

The module is integrated with the Property Account Module 120, which may include predefined escalation contacts such as the property owner, on-site manager, or preferred service vendors. For example, if the air conditioning fails during a stay and the rule profile specifies a 24-hour HVAC vendor, the module may automatically generate a service request to the designated provider, optionally including relevant metadata such as guest-reported symptoms, timestamp, and room location.

The module supports both synchronous and asynchronous alert handling. In urgent cases (e.g., no running water, security issue), the module may issue immediate push notifications or SMS alerts to the owner or designated contact. For non-urgent issues (e.g., dim lightbulb, minor appliance concern), the system may batch alerts into a daily digest or present them within the Owner Console for review.

Maintenance alerts may be tagged with status codes (e.g., “pending,” “acknowledged,” “in progress,” “resolved”) and time-to-resolution estimates. The module may also update the guest with progress updates (e.g., “Your issue has been forwarded to the service team and is expected to be resolved within 4 hours”), either automatically or upon status change.

In some embodiments, the module includes a confirmation layer that verifies whether the guest considers the issue resolved. If not, the system may prompt the owner to follow up or trigger secondary escalation. The resolution feedback is logged and may be used by the Feedback Analysis Engine 136 to identify recurring patterns or systemic property problems.

The Maintenance and Alert Module 134 may also monitor system health signals—for example, repeated guest attempts to adjust thermostat settings may trigger a silent diagnostic alert suggesting HVAC calibration—even if no explicit complaint is submitted.

Through structured detection, routing, and resolution tracking, this module reduces the friction typically associated with short-term rental maintenance. It allows the Angel AI system to serve not only as a guest-facing assistant, but also as a behind-the-scenes operational triage layer that ensures a safe and smooth stay experience while reducing owner response burden.

The Feedback Analysis Engine 136 is configured to collect, interpret, and learn from guest feedback submitted during or after their stay. This module provides a structured pipeline for translating qualitative input—such as star ratings, free-form comments, and survey responses—into actionable signals that enhance the accuracy, tone, and usefulness of future AI interactions.

Guest feedback may be captured through the Feedback Module 118, prompted automatically after key moments (e.g., check-in, mid-stay, check-out), or submitted voluntarily at any time. The engine categorizes incoming feedback into multiple dimensions including satisfaction level, issue type, praise/complaint polarity, and topic (e.g., cleanliness, communication, amenities, recommendations). Natural language processing (NLP) techniques may be applied to analyze tone, extract named entities, and detect urgency or escalation indicators within free-text comments.

In some embodiments, structured feedback scores (e.g., cleanliness: 4/5, responsiveness: 5/5) are normalized across properties to provide benchmarking data to property owners via the Owner Console. The engine may also surface recurring negative signals (e.g., “the smart lock was confusing” reported by multiple guests), which are logged and prioritized for review or retraining.

Feedback data is used not only to inform owners but also to refine system behavior. For example, if multiple guests rate the “Wi-Fi instructions” interaction poorly, the system may prompt the owner to update the content in Property Account Module 120, adjust the response format via Response Generation Module 130, or surface additional clarification prompts through the Interactive Prompt Panel 116.

The Feedback Analysis Engine 136 also supplies training signals to the Personalization Profile Manager 132. If a guest consistently responds positively to cultural event recommendations but ignores food suggestions, the system may adapt future prompt priorities or response tone accordingly. Aggregated data may also inform broader model fine-tuning or the introduction of new rule templates.

In some embodiments, the module includes temporal analysis logic to detect when satisfaction trends are changing over time (e.g., sudden drop in ratings after a renovation or seasonal uptick in positive feedback due to added amenities). These patterns can be used to preempt guest dissatisfaction or suggest optimal timing for promotions or content updates.

All feedback and its analysis outcomes are stored securely in Data Store 108, subject to guest privacy policies and data retention limits. Guests may opt out of long-term profiling, in which case the feedback is anonymized and used solely for non-personalized system optimization.

The Feedback Analysis Engine 136 closes the loop between guest perception and system performance, enabling the Angel AI platform to grow more accurate, empathetic, and operationally effective with each new interaction.

Client computing device 110 may be any suitable guest-operated endpoint, such as a smartphone, tablet, wearable device, or web-connected kiosk, used to interface with the Angel AI assistant during a vacation rental stay. In some embodiments, the device hosts a native mobile application or mobile-optimized web interface, while in others, it may interact through an embedded guest portal provided by the property management platform.

In one embodiment, the client device 110 serves as the front-end access point for all guest interactions and presents one or more modular user interface components including: (i) a Guest Chat Interface 114, (ii) an Interactive Prompt Panel 116, and (iii) a Feedback Module 118. These elements may be rendered in an integrated UI or as distinct views, depending on device form factor and interaction mode.

The Guest Chat Interface 114 is the primary conversational window through which the guest types or speaks queries to the Angel AI system. It supports free-form messaging, displays AI-generated responses in natural language, and optionally includes voice input/output capabilities using on-device speech-to-text and text-to-speech services. The interface may personalize its appearance (e.g., showing the host's photo and welcome message) based on configuration data retrieved from Property Account Module 120.

Beneath or adjacent to the chat interface, the Interactive Prompt Panel 116 provides guests with context-sensitive questions or suggestions tailored to their current situation, such as “Where can I park?”, “Late check-out options,” or “Things to do nearby.” These prompts are generated by the Recommendation Engine 124 and curated based on guest preferences identified by the Personalization Profile Manager 132. Guests may tap to activate a prompt, triggering a fully generated response without requiring them to type.

The Feedback Module 118 enables guests to provide structured ratings, submit issue reports, or offer free-form comments. This component may appear at the end of a conversation, after key milestones (e.g., check-in, maintenance response), or in response to prompts like “Was this helpful?” Feedback submitted through this module is analyzed by the Feedback Analysis Engine 136 and used to enhance both the property-specific AI behavior and the overall system intelligence.

In some embodiments, client device 110 supports GPS and device-sensor access (e.g., accelerometer, time zone, battery state), which may be used by the system to further contextualize responses. For example, if the device reports a location near the property but outside the building, the system may automatically surface entry instructions or parking info. Similarly, low battery detection may trigger a proactive message with the location of nearby power outlets or charging stations.

The client device 110 may operate over Wi-Fi or cellular connections and is configured to transmit interaction data to the AI Vacation Server Device 102 through encrypted channels. Communication may be facilitated by HTTPS, WebSocket, or similar protocols that support low-latency exchanges and support real-time conversational continuity.

Although the user interface presented on client device 110 may vary depending on property branding, platform design, or third-party integrations, the underlying architecture remains consistent: device 110 provides the guest-facing input/output layer, while decision logic, rule enforcement, and personalization are handled by server-side modules. This division of responsibility ensures scalability, consistent guest experience, and low-friction deployment across a wide range of devices and operating environments.

The Guest Chat Interface 114 is the primary conversational touchpoint between the guest and the Angel AI system. It supports real-time, bidirectional interaction in text or voice form, and serves as the front-end window through which guests can ask questions, receive recommendations, report issues, and receive system notifications.

Upon check-in or initial launch, the interface may display a personalized welcome message and property branding, including the host's name, photo, and a greeting configured via Property Account Module 120. The chat interface operates using a natural language interface, supporting both typed and spoken input depending on device capabilities and user preference.

Messages exchanged through the Guest Chat Interface 114 are routed to the Guest Interaction Engine 122, which analyzes guest input and generates responsive, rule-compliant replies using modules 124-130. Responses are rendered in-line and may include embedded media, maps, links to external services, and interactive elements.

The chat interface also supports adaptive response formatting based on device size, guest profile preferences, and interaction history. For example, concise bullet-point replies may be used for guests who have previously rated “brief responses” more favorably, while detailed paragraphs may be used for guests seeking more guidance.

In some embodiments, the Guest Chat Interface 114 may include visual indicators such as typing animations, timestamps, or confirmation icons to improve transparency and trust. The interface may also notify guests when an issue has been escalated to a property owner or service provider via the Maintenance and Alert Module 134.

The Interactive Prompt Panel 116 is a context-sensitive user interface component positioned beneath or adjacent to the chat input field. It presents dynamically generated prompt buttons that anticipate common guest queries or actions relevant to the guest's current context, time of day, or prior interactions.

Prompt suggestions may include entries such as “View Wi-Fi instructions,” “Check-out details,” “Book a restaurant,” or “Local attractions nearby.” These prompts are generated by the Recommendation Engine 124 and are personalized using behavioral data from the Personalization Profile Manager 132 and session context retrieved by the Guest Interaction Engine 122.

When a guest selects a prompt, the system processes it as if the guest had typed a corresponding free-text message. This enables low-friction interaction and is particularly valuable for users unfamiliar with the system or unsure of what to ask. Prompt panels may be refreshed dynamically as guest context evolves—for example, changing from check-in prompts to local activity suggestions as the day progresses.

In some embodiments, prompt rankings are influenced by aggregate guest usage patterns, owner-defined emphasis (e.g., “Highlight coffee shops”), or ongoing system learning based on feedback and engagement metrics. Prompts may also trigger follow-up questions or micro-flows, such as presenting available reservation slots via the Reservation Integration API 176.

The panel is designed to minimize friction and increase guest engagement, particularly for first-time users, international travelers, or guests interacting with the AI assistant in a second language.

The Feedback Module 118 enables guests to provide structured and unstructured feedback about their stay or specific interactions with the Angel AI assistant. It supports submission of star ratings, predefined satisfaction indicators (e.g., “Quick response,” “Not helpful”), issue reports, and free-text comments.

This module may appear at predefined moments such as post-check-in, following issue resolution, at check-out, or after high-value interactions like a booking or recommendation. It may also be invoked by the guest at any time via a “Give Feedback” button within the Guest Chat Interface 114.

Feedback collected via this module is routed to the Feedback Analysis Engine 136, where it is processed, categorized, and used to improve the AI system's future behavior. Structured ratings may influence property-level performance scores, while free-text comments may be parsed for topic extraction, sentiment analysis, and escalation signals.

In some embodiments, the module includes confirmation dialogs (“Thanks for your input!”), optional guest anonymity settings, and progress indicators that display how the feedback will be used. Feedback related to unresolved issues may be automatically forwarded to the property owner via the Maintenance and Alert Module 134.

The Feedback Module 118 supports responsive UI behavior, adapting to device form factor, accessibility settings (e.g., large text), and guest language preferences. It enables the Angel AI system to operate as a closed-loop hospitality platform that not only responds to guest needs, but learns from them to continuously improve.

The Owner Console Module 138 is configured to provide property owners, managers, and authorized staff with a secure, web-based or app-accessible interface for reviewing and managing their property's Angel AI configuration, performance, and guest engagement. While the guest experience is mediated through client device 110, the Owner Console is expressly designed for non-guest users who are responsible for administering the vacation rental property.

The Owner Console is not visible or accessible to guests. It is typically used by the individual or entity that owns, manages, or oversees the rental property, and is authenticated through account credentials tied to the Property Account Module 120. Each instance of the Angel AI system may be associated with one or more owner or manager profiles, depending on the property management structure.

Through the Owner Console, users may configure or update property rules (e.g., quiet hours, amenity restrictions), upload new welcome messages or host photos, and modify check-in/out instructions. Changes made through the console are committed to Data Store 108 and immediately reflected in system behavior through the Property Rules Processor 128 and Response Generation Module 130.

The console also serves as a monitoring dashboard. It may display recent guest inquiries, unresolved maintenance issues, live alerts, satisfaction trends, and engagement analytics. For example, if multiple guests report confusion about thermostat usage, this insight may be surfaced with a recommended update to the property guide.

In some embodiments, the Owner Console Module 138 includes tiered permission controls, enabling delegation of responsibilities to property managers, cleaning staff, or concierge services. Each role may be granted access to specific views—e.g., maintenance logs without chat histories, or analytics without editing permissions.

The module may also provide summaries or alerts triggered by the Feedback Analysis Engine 136, such as dips in satisfaction scores, repeated negative mentions, or emerging guest behavior patterns. In certain implementations, the console may include a scheduling interface to coordinate vendor dispatch or preventive maintenance in response to guest-reported concerns.

All updates made through the Owner Console are logged and may be version-controlled to support transparency and rollback capability. In cases of complex system behavior or disputed guest feedback, owners may audit historical AI responses and trace their provenance to specific configuration settings or rule logic.

By providing a dedicated and secure portal for owners and their authorized representatives, the Owner Console Module 138 ensures that administrative users have full visibility and control over their property's AI behavior without interfering with the guest-facing experience. It enables owners to configure preferences, enforce policies, respond to emerging issues, and optimize the guest journey—all while preserving system-wide automation, scalability, and compliance.

In some embodiments, an AI assistant operates as the central orchestrator for guest-facing interactions and personalized automation across vacation rental properties. The assistant interfaces with modules including the guest interaction engine (122), knowledge base module (126), personalization profile manager (128), and rules and escalation engine (130) to deliver context-aware, property-specific responses through the guest chat interface (124).

In some embodiments, the assistant dynamically interprets guest input, applies tone or sentiment modifiers, and adapts response delivery based on property configurations, guest history, and emotional context. In some embodiments, the assistant is further configured to generate responses using an AI voice persona selected via the voice configuration manager (132), enabling optional voice playback or audio-based engagement. Unlike traditional systems, the assistant operates autonomously within rule-based constraints defined by the property owner, while incorporating adaptive learning via the training and adaptation engine (138). This allows for increasingly personalized guest interactions without requiring manual intervention from the owner.

External Services 170 represents a collection of third-party and partner-integrated systems that supplement the Angel AI platform with real-time, location-based, or dynamic data that enhances guest recommendations, response accuracy, and operational utility. These services are accessed by the AI Vacation Server Device 102 through network 103 via secure APIs and may include public datasets, commercial content providers, or proprietary integrations.

External services are modular and extensible—meaning the system may support only a subset of them in any given deployment depending on property type, geographic region, or owner preference. Each component may be queried synchronously (as part of a guest interaction flow) or asynchronously (e.g., batch content updates or rule verification).

The Map and Navigation API 172 provides geospatial data to support navigation instructions, property directions, nearby landmark identification, and local context enrichment. The Angel AI system uses this API to answer queries such as “How do I get to the nearest grocery store?” or “Can you show me a walking route to the museum?”

This module may integrate with services such as Google Maps®, Apple Maps®, OpenStreetMap®, or a white-labeled provider, and may return data in the form of estimated travel time, walking/driving routes, maps, and embedded navigation links. It may also support geofencing capabilities—for example, detecting that a guest has entered the neighborhood and triggering a contextual welcome message.

The Review Aggregator API 174 connects to external platforms that collect and curate user reviews of restaurants, tourist attractions, bars, and service providers. The system queries this API to retrieve rating scores, popularity rankings, tags (e.g., “romantic,” “family-friendly”), and guest-submitted photos or menus.

These data points are used by the Recommendation Engine 124 to enhance the quality and trustworthiness of suggestions presented to the guest. For instance, if two nearby restaurants are otherwise similar, the one with higher recent reviews may be prioritized. The guest may also be presented with an interactive response containing embedded snippets (e.g., “4.5 stars on Yelp®,” “Top 10 on TripAdvisor®”).

The Reservation Integration API 176 allows guests to book third-party services (e.g., restaurants, tours, spa appointments, or bike rentals) directly from within the Angel AI interface. The API may be connected to platforms such as OpenTable®, Resy®, Viator®, or property-specific partner systems.

When a guest expresses intent to make a reservation—either explicitly (“Can you book a table for 2 at 7 pm?”) or through action (e.g., clicking a prompt)—the system uses this API to check real-time availability, present options, and complete the booking process. The confirmation may be rendered back into the Guest Chat Interface 114 or stored in the guest profile for later reference.

The External Content Verifier API 178 serves as a fact-checking and validation layer for time-sensitive or guest-supplied information. It is used to confirm details such as event hours, temporary closures, admission fees, weather alerts, or traffic disruptions. This ensures that the AI assistant does not surface outdated or incorrect recommendations.

In some embodiments, the verifier API also compares owner-uploaded content against authoritative sources to detect inconsistencies. For example, if an owner states that a local shuttle stops in front of the property, but transit APIs show otherwise, the system may flag the discrepancy for review.

This module enhances the reliability of Angel AI and reduces the chance of negative guest experiences due to outdated or misleading information. It may also integrate with municipal datasets, public event calendars, tourism bureaus, or custom-curated feeds provided by property managers or regional partners.

Together, the external service components 172-178 expand the reach and contextual awareness of the Angel AI system, allowing it to provide timely, trustworthy, and interactive responses that go beyond static property data and engage meaningfully with the surrounding environment.

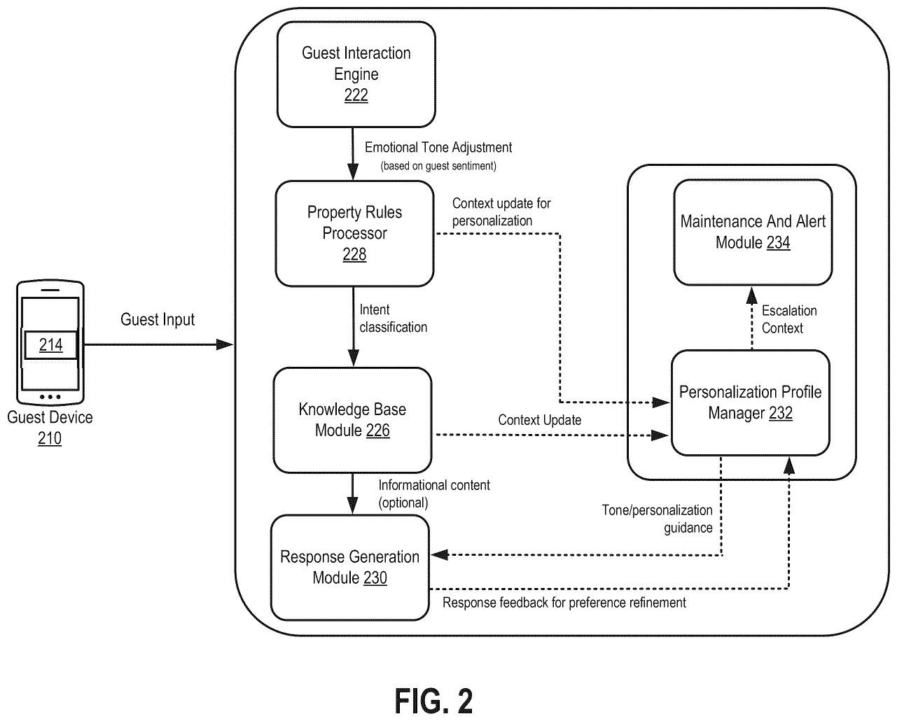

FIG. 2 illustrates an example interaction flow diagram depicting how a guest input is processed and handled by the AI-driven vacation assistant system, according to one embodiment of the disclosure. The flow begins when a guest enters a query, selection, or prompt using the Guest Chat Interface 214 on Guest Device 210. The system receives this input and routes it to the Guest Interaction Engine 222 for parsing and semantic analysis. The Guest Interaction Engine 222 analyzes the guest input to extract intent, sentiment, and contextual cues, which may include urgency, emotional tone, or linguistic style. Based on detected sentiment, the engine may initiate an emotional tone adjustment process, relaying tone-related parameters to the Property Rules Processor 228. This allows downstream components to adapt responses with an appropriate delivery style (e.g., empathetic, enthusiastic, urgent).

The Property Rules Processor 228 performs an initial classification of the guest's request and determines whether the inquiry is governed by any property-specific rules, restrictions, or customized behaviors. The processor accesses relevant rules and behavioral logic configured within the Property Account Module (not shown in this figure) and relays contextual updates to the Personalization Profile Manager 232. These updates may include changes in guest behavior patterns, new contextual triggers, or policy-linked constraints.

In some cases, the Property Rules Processor 228 may identify an intent classification that aligns with knowledge-driven content—such as FAQs, localized instructions, or curated guides. In such instances, the system queries the Knowledge Base Module 226 to retrieve informational content to support response construction. This information may be routed directly to the Response Generation Module 230 or stored temporarily for fallback purposes.

The Response Generation Module 230 synthesizes a natural-language reply based on the guest's input, relevant property rules, optional knowledge base content, and tone/personalization guidance received from the Personalization Profile Manager 232. The generated response is returned to the Guest Chat Interface 214 on device 210. The module also logs interaction outcomes—including guest engagement, prompt selection, satisfaction signals, or follow-up activity—and sends this feedback to Profile Manager 232 for adaptive preference refinement.

The Personalization Profile Manager 232 continuously refines its understanding of each guest's preferences, interaction styles, and emotional responsiveness using real-time and historical data. It provides response-tuning guidance to module 230 and may trigger escalation pathways to the Maintenance and Alert Module 234 if guest behavior or system-detected conditions indicate a service issue or policy violation. In such cases, escalation context—such as emotional tone, issue category, and guest profile—is packaged and routed to the appropriate resolution module or owner-facing interface (e.g., Owner Console 138).

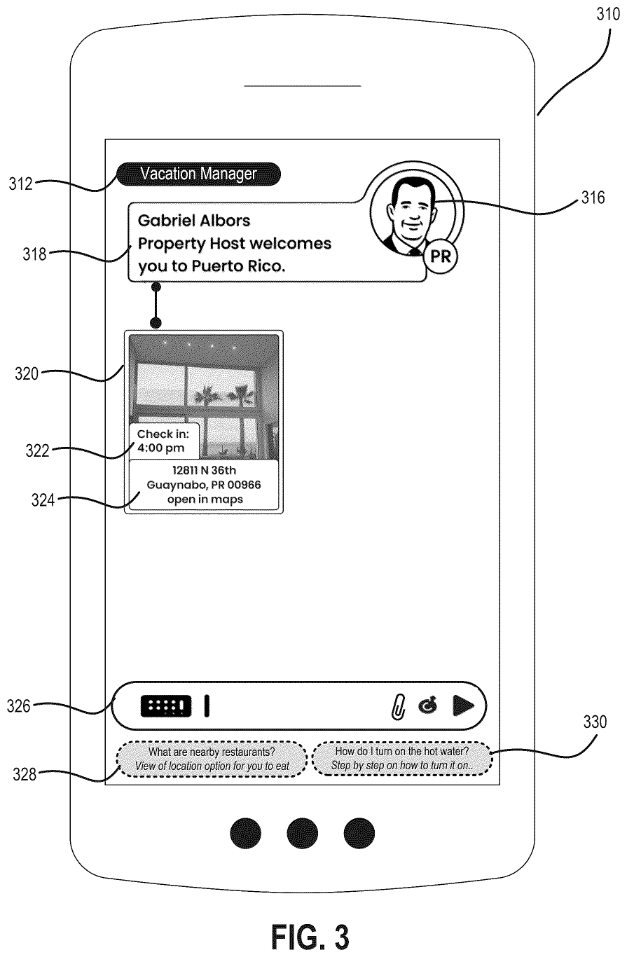

FIG. 3 illustrates an example graphical user interface (GUI) rendered on a guest's client computing device 310, displaying a personalized interaction with the Angel AI system, here labeled as “Vacation Manager.” The interface enables a guest to receive timely property-specific information, guidance, and context-aware suggestions from the AI system while maintaining a familiar, friendly, and conversational format.

The GUI begins with a system label 312 reading “Vacation Manager,” identifying the AI assistant instance assigned to the current vacation rental. In some embodiments, this label may include branding or a customized name configured by the property owner or manager.

A welcome message 318 is prominently displayed in the interface, visually anchored by a host profile graphic 316 representing the owner or manager associated with the rental property. The host identity—here, “Gabriel Albors”—is displayed alongside a brief greeting customized to the location or time of arrival. In some embodiments, the welcome message 318 is dynamically composed based on guest reservation data or local context, and may include links or interactive options for initiating a help session.

A visual check-in module 320 displays a photo of the vacation property or a relevant interior image, optionally selected by the owner or system from a curated media set. The image may assist with check-in confidence or location recognition.

Immediately below the image, the interface displays structured check-in data 322, including the designated time for arrival. This information is retrieved from the Property Account Module (see FIG. 1, 120) and may update in real time if modified by the owner or external system (e.g., a property management platform).

A location card 324 displays the rental address and an optional “open in maps” link, allowing the guest to initiate navigation using their preferred GPS service. In some embodiments, geofencing logic may trigger location-aware messages when the guest approaches the address.

Below the core message area, the interface presents an interactive message entry panel 326. This panel may include voice input triggers, emoji or reaction buttons, quick tap suggestions, or a text entry field. The panel facilitates natural back-and-forth with the Vacation Manager and allows multimodal input.

Beneath the panel, a prompt carousel 328 displays dynamically generated questions tailored to the guest's context. These prompts are produced by the Response Generation Module 230 (see FIG. 2), and may reflect frequently asked questions, guest interests, property rules, or emerging guest patterns. Example prompts may include “What are nearby restaurants?” or “How do I turn on the hot water?” Guests may tap to auto-initiate a query without having to type.

The overall screen 330 encompasses the interactive region rendered on the display of client device 310. While FIG. 3 shows a mobile layout, other embodiments may render a responsive version of this interface on tablet, web, or embedded screen devices (e.g., smart thermostats or in-property kiosks).

The interface depicted in FIG. 3 provides an intuitive and visually engaging medium through which guests interact with the Angel AI system. It reduces guest confusion, promotes quick access to critical information, and increases guest satisfaction through real-time, property-aware responsiveness. All GUI content may be modified via the Owner Console Module 138 (see FIG. 1), enabling property managers to tailor the experience to specific guest needs or brand identity.

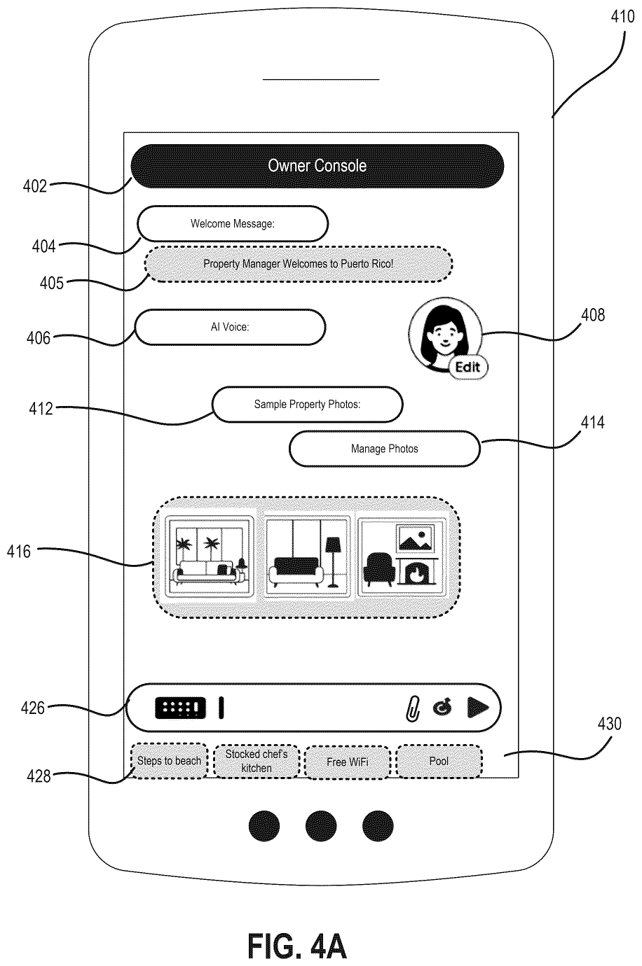

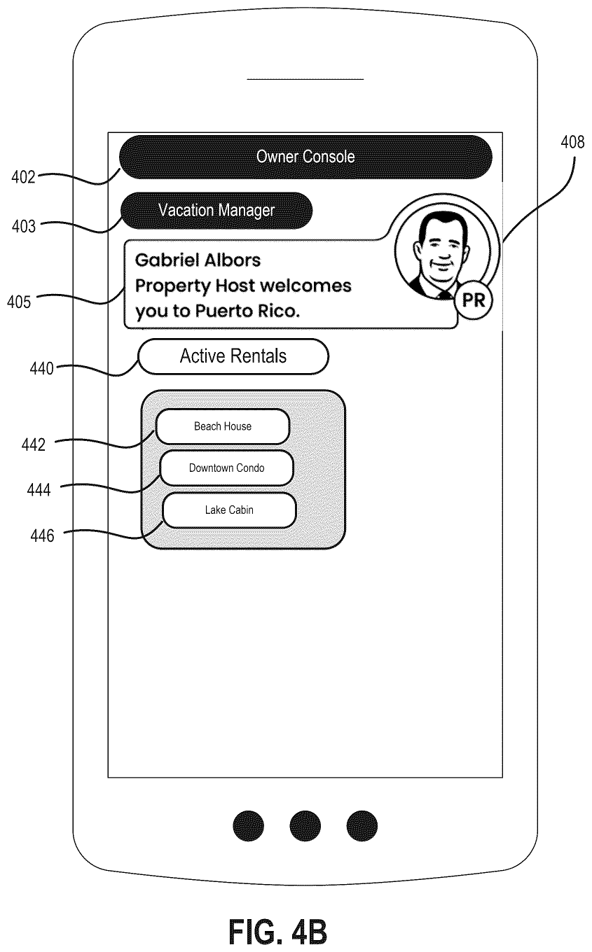

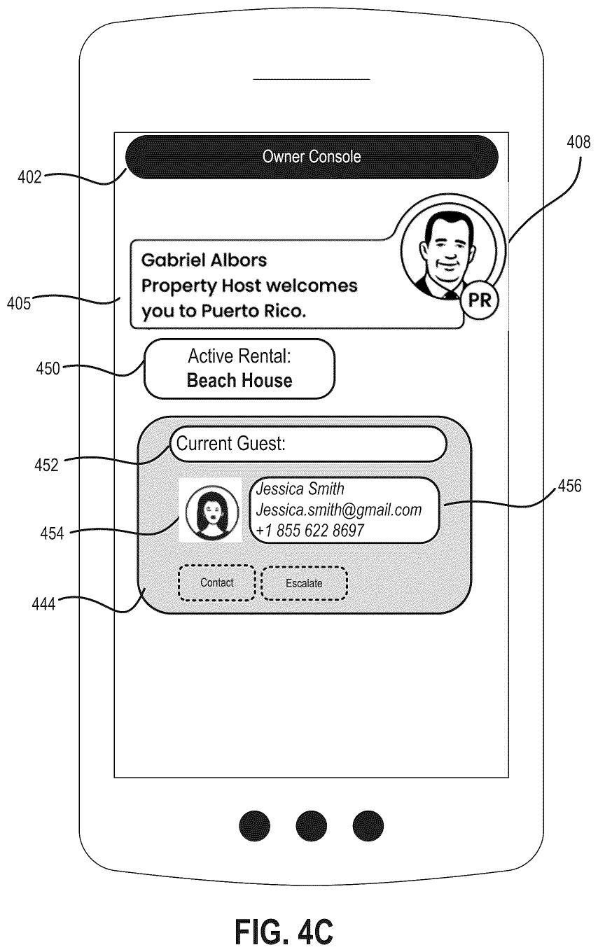

FIG. 4A illustrates an example graphical user interface (GUI) rendered on an owner's client computing device 410, displaying an Owner Console interface that enables property managers to configure and personalize their Vacation Manager (Angel AI) instance. This console provides a centralized, visual environment for curating guest experiences, managing content, and customizing AI-driven interactions.

The interface includes a screen title 402 labeled “Owner Console,” establishing the context of the interface as a control panel for host-side functions. A message label 404 is positioned below the title, corresponding to a welcome message entry field 405. In some embodiments, this welcome message may be dynamically inserted into the guest-facing interface (see FIG. 3) as part of the initial greeting shown to arriving guests.

The interface further includes a configuration label 406 labeled “AI Voice,” paired with a profile avatar 408 representing the current AI voice persona assigned to the Vacation Manager. Selecting this avatar or an associated “Edit” button enables the property owner to customize the voice style, tone, gender, or language of the AI assistant. In some embodiments, the AI Voice may be based on: predefined voice profiles (e.g., professional, warm, regional accent), A voice clone of the owner or host, a preferred language or dialect setting, a dynamic tone modulator linked to time of day or guest sentiment. The system may provide an interface for previewing or testing the selected voice, as well as storing voice preference metadata in the property's AI configuration profile.

Below the AI Voice section, the interface includes a label 412 for “Sample Property Photos” and an adjacent “Manage Photos” button 414. This region allows the property owner to view and curate the visual assets that will be displayed to guests (e.g., in the check-in flow of FIG. 3). The primary photo carousel 416 is shown with multiple sample property photos, including the selected main image and alternate options representing interior and exterior views. In some implementations, owners may designate photo priority or tag images with categories (e.g., bedroom, kitchen, pool).

Below the media section, an interaction panel 426 allows owners to test the interface from a guest's perspective. This panel may also be used to simulate input types such as voice, emoji feedback, or typed queries. A system control row 430 may provide options to preview how the Vacation Manager responds to selected voice and image settings, reset test parameters, or switch between property accounts.

At the bottom of the screen, the interface includes a keyword or badge input row 428. These elements allow owners to define feature highlights or searchable tags (e.g., “Steps to beach,” “Free Wifi,” or “Stocked chef's kitchen”) that influence recommendation logic, guest query responses, or listing presentation. The defined keywords may be used by the Response Generation Module (see FIG. 2, 230) to tailor auto-suggestions and enhance contextual relevance during live guest interactions.

The Owner Console interface shown in FIG. 4A provides a streamlined and intuitive control layer for managing the visual, verbal, and behavioral elements of the AI-driven guest experience. It empowers property owners to maintain brand consistency, ensure clarity in communications, and dynamically respond to evolving guest expectations—all without requiring technical expertise.

FIG. 4B illustrates an alternate view of the Owner Console interface displayed on an owner's client computing device, enabling the property manager to select from among multiple active vacation rental properties associated with their account. This selection interface supports seamless toggling between property-specific configurations and AI customization options.

The screen includes a persistent console title 402 (“Owner Console”) and an instance label 403 identifying the current AI assistant persona (“Vacation Manager”) assigned to the owner's account. A welcome message 405, paired with a host profile image 408, mirrors the header components shown in FIG. 4A and may be reused across interface views for brand continuity.

Positioned below the welcome header is a section label 440 (“Active Rentals”), which introduces a selectable rental unit menu 442-446. In the illustrated embodiment, the rental list includes three active property listings: Beach House 442, Downtown Condo 444, and Lake Cabin 446. Each listing is rendered as a selectable GUI element. Upon selection, the interface may transition to a property-specific console (e.g., the configuration screen of FIG. 4A), allowing the user to edit the AI Voice, welcome message, sample photos, and personalization tags associated with that specific property.

In some embodiments, the property list shown in FIG. 4B is dynamically generated from the property account module 120 (see FIG. 1), which tracks individual rental profiles under a single owner's account. The system may pull metadata such as unit name, status (e.g., booked, available, inactive), and past interaction metrics to populate the display. Properties can be sorted by usage frequency, guest rating, or upcoming booking dates.

In alternative implementations, each listing element 442-446 may include additional context such as guest check-in date, unread messages, or maintenance flags. Selecting a property may also enable backend filtering of analytics, feedback, or AI behavior patterns associated with that property only.

The Active Rentals view enhances the manageability of the AI Vacation Manager system for hosts overseeing multiple listings, enabling granular personalization without requiring duplicate accounts or separate logins.

FIG. 4C illustrates another example interface screen of the Owner Console rendered on a client computing device, focusing on current guest management for a selected property. This view provides the property owner with real-time visibility into active bookings and supports responsive interaction or escalation workflows if needed.

The interface maintains a consistent header design with screen title 402 (“Owner Console”) and host profile region 408, along with a message block 405 welcoming the guest to the currently selected rental unit. A section label 450 indicates the selected rental property—in this case, “Beach House”—as previously chosen from the active property list shown in FIG. 4B.

Beneath the property label is a section labeled “Current Guest” 452, which displays a dynamically generated card-style interface element 456 summarizing guest identity and contact information. In the depicted embodiment, guest Jessica Smith is currently associated with the rental, and the guest card includes: Guest name and profile image, Email address, and Phone number.

This guest metadata is typically retrieved from the property account module 120 and populated via integration with reservation APIs (e.g., 172 in FIG. 1) or manual entry via the owner portal. The interface also includes two action buttons 454: A “Contact” button that may initiate a call, text, or email message through a built-in communication workflow. An “Escalate” button that allows the owner to flag the interaction for priority review, trigger intervention (e.g., concierge service, support staff), or invoke the AI system's fallback resolution mode if the Vacation Manager has detected low guest sentiment or unresolved issues.

In some embodiments, the “Current Guest” section may also show booking duration, check-in/check-out status, message history, or response satisfaction scores. The escalation logic may feed into the maintenance and alert module 134 and/or personalization profile manager 132 to fine-tune AI tone and future interactions.

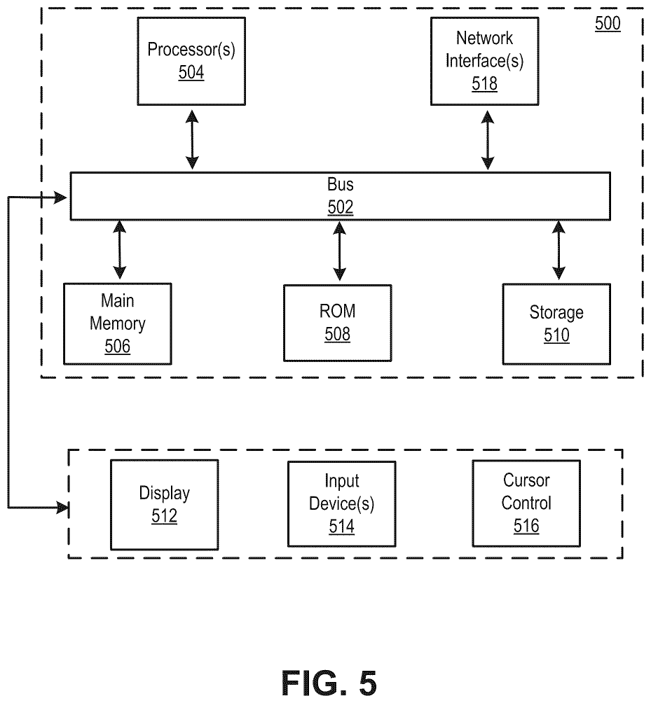

FIG. 4C supports high-context guest management by consolidating relevant details into a single screen and enabling swift action. By coupling real-time data with AI-driven escalation options, this interface ensures that property owners can maintain visibility and responsiveness without micromanagement.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 5. Various embodiments are described in terms of this example computing module 500. After reading this description, it will become apparent to a person skilled in the relevant art how to implement the technology using other logical circuits or architectures.

FIG. 5 illustrates an example computing module 500, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 3. Various embodiments are described in terms of this example-computing module 500. After reading this description, it will become apparent to a person skilled in the relevant art how to implement the application using other computing modules or architectures.

Referring now to FIG. 5, computing module 500 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 500 might include, for example, one or more processors, controllers, control modules, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing module 500 or to communicate externally. The bus 502 may also be connected to other components such as a display 512, input devices 514, or cursor control 516 to help facilitate interaction and communications between the processor and/or other components of the computing module 500.

Computing module 500 might also include one or more memory modules, simply referred to herein as main memory 506. For example, preferably random-access memory (RAM) or other dynamic memory might be used for storing information and instructions to be executed by processor 504. Main memory 506 might also be used for storing temporary variables or other intermediate information during execution of instructions to be executed by processor 504. Computing module 500 might likewise include a read only memory (“ROM”) 508 or other static storage device 510 coupled to bus 502 for storing static information and instructions for processor 504.

Computing module 500 might also include one or more various forms of information storage devices 510, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 510 might include other similar instrumentalities for allowing computer programs or other instructions or data to be loaded into computing module 500. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 500.

Computing module 500 might also include a communications interface or network interface(s) 518. Communications or network interface(s) interface 518 might be used to allow software and data to be transferred between computing module 500 and external devices. Examples of communications interface or network interface(s) 518 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 518 might typically be carried on signals, which can be electronic, electromagnetic (which includes optical) or other signals capable of being exchanged by a given communications interface. These signals might be provided to communications interface 518 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 506, ROM 508, and storage unit interface 510. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 500 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented system for managing personalized guest interactions in vacation rental properties, comprising:
a processor;
a memory coupled to the processor; and
a non-transitory computer-readable medium storing instructions that, when executed by the processor, cause the system to:
receive guest input via a guest chat interface rendered on a client device;
process the guest input using a guest interaction engine to extract emotional tone and conversational intent;
classify the guest intent using a property rules processor configured based on property-specific configurations;
query a knowledge base module to retrieve informational content relevant to the classified intent;
generate a response using a response generation module, wherein the response is adapted to the emotional tone and property context;
transmit the response to the guest chat interface; and
update a personalization profile manager based on guest interaction history, tone feedback, or preference indications.

2. The system of claim 1, wherein the instructions further cause the system to update a maintenance and alert module based on escalation triggers derived from guest sentiment, intent classification, or interaction failures.

3. The system of claim 1, wherein the guest interaction engine adjusts emotional tone by applying sentiment analysis to guest input and modulating the style of response accordingly.

4. The system of claim 1, wherein the personalization profile manager refines future response generation based on feedback data collected through guest interaction, including response selection, skipped prompts, or explicit guest preferences.

5. The system of claim 1, further comprising an owner console interface rendered on an owner device, the interface comprising:
a property management dashboard;
a user-editable welcome message field;
a photo gallery interface for uploading and tagging property images; and
a selectable AI voice configuration panel for defining a vocal persona used in guest communications.

6. The system of claim 5, wherein the AI voice configuration panel allows the property owner to select a voice gender, accent, tone setting, or voice twin generated from a custom audio input.

7. The system of claim 1, further comprising a guest-facing user interface that displays:
a welcome message personalized to the property and guest profile;
property details including check-in time and location links; and
interactive prompt suggestions generated based on property context and guest data.

8. The system of claim 1, wherein the property rules processor is configured with owner-defined restrictions or preferences, including quiet hours, pet policies, or amenity-specific rules.

9. The system of claim 1, wherein external data sources are accessed via one or more APIs selected from:
a reservation integration API,
a review aggregation API,
a map and navigation API, and
an external content verifier API.

10. A computer-implemented method for managing guest interactions in a vacation rental property, the method comprising:
receiving, via a guest chat interface on a guest device, a user input from a guest;
analyzing the user input using a guest interaction engine to detect emotional tone and determine conversational intent;
classifying the intent using a property rules processor configured with owner-defined preferences or policies;
retrieving informational content from a knowledge base module based on the classified intent;
generating a response using a response generation module, wherein the response is adapted based on the emotional tone and the personalization context;
transmitting the response to the guest chat interface; and
updating a personalization profile manager based on guest interaction data, including tone signals, feedback, or behavioral cues.

11. The method of claim 10, further comprising:
triggering a context update to a maintenance and alert module when the personalization profile manager detects escalation criteria based on the guest input or sentiment score.

12. The method of claim 10, wherein the emotional tone is determined using sentiment analysis techniques applied to one or more of: message wording, punctuation patterns, or interaction pacing.

13. The method of claim 10, wherein the personalization profile manager updates guest preferences by analyzing selections made from among interactive prompt suggestions, response reaction timing, or skipped content.

14. The method of claim 10, further comprising:
displaying, on the guest chat interface, a personalized welcome message, a check-in location card, and a property image associated with the current reservation.

15. The method of claim 10, wherein the property rules processor enforces owner-defined conditions by:
filtering guest requests that violate predefined restrictions; and
redirecting the conversation to alternative recommendations or clarifications.

16. The method of claim 10, wherein the step of generating a response includes:
applying tone or stylistic variations aligned with emotional tone guidance received from the personalization profile manager.

17. The method of claim 10, further comprising:
retrieving data from one or more external APIs to enhance the generated response, the external APIs comprising: a map and navigation API, a reservation integration API, a review aggregation API, or an external content verifier API.
